(19) United States
(12) Patent Application Publication
(10) Pub. No.: US 2014/0106023 A1
(43) Pub. Date: Apr. 17, 2014

(54) ANIMAL FEED AND/OR WATER AMENDMENTS FOR LOWERING AMMONIA CONCENTRATIONS IN ANIMAL EXCREMENT

(71) Applicant: SPECIALTY FERTILIZER PRODUCTS, LLC, Leawood, KS (US)

(72) Inventor: John Larry Sanders, Leawood, KS (US)

(21) Appl. No.: 13/791,263

(22) Filed: Mar. 8, 2013

Related U.S. Application Data
(60) Provisional application No. 61/713,757, filed on Oct. 15, 2012.

(51) Int. Cl. A23K 1/16

(52) U.S. Cl. CPC A23K 1/1646
USPC 426/2; 426/635; 426/623; 426/630; 426/66

(57) ABSTRACT

Improved animal feeds and/or waters are provided, which include amendments comprising a partial calcium salt of a maleic-itaconic copolymer and a partial ammonium salt of a maleic-itaconic copolymer. The copolymers are preferably water soluble and have substantially equimolar amounts of maleic and itaconic moieties. The improved feeds and/or waters reduce volatilized ammonia derived from the decomposition of animal excrement.

### CROSS-REFERENCE TO RELATED APPLICATION

This application claims the benefit of Provisional Application Ser. No. 61/713,757 filed Oct. 15, 2012 incorporated by reference herein in its entirety.

### BACKGROUND OF THE INVENTION

1. Field of the Invention

The present invention is broadly concerned with animal feed and/or water amendments, and corresponding methods, which are designed to reduce the amount of gaseous ammonia resulting from the decomposition of animal excrement (i.e., manure and urine). More particularly, the invention is concerned with such amendments comprising a partial calcium salt of a maleic-itaconic copolymer and a partial ammonium salt of a maleic-itaconic copolymer, which can be added to animal feed and/or water. A variety of livestock animals may be treated using the invention, including poultry and mammals.

2. Description of the Prior Art

Ammonia is a common by-product of animal waste due to the often inefficient conversion of feed nitrogen into animal protein. Poultry are often fed high-protein diets, which contain surplus nitrogen in order to assure that the animals' nutritional requirements are met. Nitrogen that is not metabolized into animal protein is secreted in the feces of poultry, where further microbial action release ammonia into the air during manure decomposition. In like manner, ruminants such as cattle are often fed non-protein nitrogen (NPN) as a part of their normal diets, and this can also exacerbate the problem of excess ammonia in cattle excrement.

Ammonia is typically considered an indoor air quality concern by animal producers, because the gas accumulates inside containment facilities such as poultry houses and cattle barns. Elevated levels of ammonia can have a negative impact on animal health and production, resulting in increased susceptibility to bacterial respiratory infection, decreased weight gains, and feed conversions.

Producers have adopted a number of strategies to lessen ammonia levels resulting from decomposition of animal manure and urine. Thus, it is known that a variety of treatments including aluminum sulfate (alum), ferrous sulfate, phosphoric acid, and other proprietary products may be sprayed or otherwise applied to poultry litter. Producers have also sought to minimize atmospheric ammonia in poultry containment facilities by manipulating poultry diets. The usual strategy is to provide feeds which reduce the amount of nitrogen excreted by the poultry. For example, one dietary manipulation involves supplying poultry with the amino acid needed, including crystalline amino acids, instead of supply feed based primarily on crude protein content. Also, efforts have been made to add fermentable carbohydrates, such as bran or pulp, into grow-finishing diets. However, these efforts, while marginally reducing gaseous ammonia, have not fully answered the need to significantly ameliorate the ammonia problem.

Specialty Fertilizer Products, LLC, of Leawood, Kans. (SFP), has heretofore commercialized a series of maleic-itaconic copolymers principally for use with solid or liquid ammoniacal or phosphate fertilizers, such as urea or UAN fertilizers, in order to significantly increase the performance of the fertilizers as evidenced by increased yields.

These prior products include Nutrisphere-N® for Liquid Nitrogen Fertilizers, which is a partial calcium salt of a maleic-itaconic copolymer in water with a solids content of at least 30% w/w, and more preferably about 40% w/w. The copolymer is formulated using equimolar amounts of maleic and itaconic moieties. The final product has a pH of 1-2 and is a light brown to yellow viscous liquid.

Another such product is AVAIL® for Liquid Phosphate Fertilizers is a partial ammonium salt of a maleic-itaconic copolymer in water with a solids content of at least 30% w/w, and more preferably about 40% w/w. The copolymer is formulated using equimolar amounts of maleic and itaconic moieties. The final product has a pH of about 2 and is also a light brown to yellow viscous liquid.

SFP has also previously commercialized a manure nutrient manager product under the trademarks More Than Manure® or MTM®, which is primarily designed to reduce phosphorous lock-up and nitrogen loss when applied to manure in an open-air pit or lagoon, or directly onto litter after field application of the litter. MTM® is an aqueous mixture made up of two-thirds by volume Nutrisphere-N® for Liquid Nitrogen Fertilizers and one-third by volume of AVAIL® for Liquid Phosphate Fertilizers, having a solids content of from about 30-60% w/w, a pH of about 3 and a specific gravity of from about 1.1-1.4. Other benefits of the MTM® product include increased crop rotation flexibility, biodegradability, and reduction of manure solids. In such prior uses of MTM®, no odor-reduction studies were conducted, but numerous MTM® users expressed the opinion of a notable reduction of odor from the use of the product.

### SUMMARY OF THE INVENTION

It has now been discovered that highly useful animal feed and/or water amendments can be provided which serve to significantly reduce gaseous ammonia concentrations in animal containment facilities. In particular, it has been found that amendments including a partial calcium salt of a maleic-itaconic copolymer, and a partial ammonium salt of a maleic-itaconic copolymer, can be added to animal feed and/or water to good effect. For example, conventional poultry feeds comprising feed ingredients including quantities of corn and soybean meal can be improved using the amendments of the invention. In like manner, poultry water may be supplemented with the amendments. In either instance, the amount of amendment used should be sufficient to reduce volatilized ammonia derived from the feces of poultry, as compared with poultry receiving the same feed and/or water, but without the amendments. Similarly, mammalian animal feeds and waters can be improved by the addition of the copolymers of the invention, again in amounts sufficient to reduce volatilized ammonia derived from mammalian excrement, as compared with animals receiving the same feed and/or water, but without the amendments.

In one preferred implementation of the present invention, poultry feeds and/or waters are supplemented with a minor amount of the previously described MTM® product. In the case of poultry feed supplementation, the MTM® is usually used at a level of from about 0.05-0.25% by weight (corresponding to 387-1900 mls of MTM® per ton of feed), where the total amount of the supplemented feed is taken as 100% by weight. Where poultry water is supplemented, the MTM® should be used at a level of from about 0.01-0.25% by volume (corresponding to 7.57-189 mls of MTM® per 20 gallons of water), more preferably from about 0.1-0.2% by volume, where the total amount of the supplemented water is taken as 100% by volume.

Employment of the copolymers of the invention as mammalian feed and/or water amendments is also highly useful. In the case of cattle, e.g., the feed should be supplemented with from about 0.01-1% by weight, and more preferably from about 0.1-0.4% by weight of the partial calcium and ammonium salts of the maleic-itaconic copolymers of the invention. Mammalian water may be supplemented with 0.01-1% by volume, more preferably from about 0.1-0.4% by volume of the same copolymer partial salts.

### DETAILED DESCRIPTION OF THE PREFERRED EMBODIMENT

### The Partial Salt Maleic-Itaconic Copolymers and the Amendments

The preferred maleic-itaconic copolymers useful in the invention are described in U.S. Pat. Nos. 6,515,090 and 8,043,995 fully and completely incorporated by reference herein. In general, the copolymer salts should each desirably contain from about 10-90% by weight maleic moieties (more preferably from about 25-75% by weight), and correspondingly from about 90-10% by weight itaconic moieties (more preferably from about 75-25% by weight). Overall, each of the copolymer salts should include at least about 85% by weight of maleic and itaconic moieties, and more preferably at least about 93% by weight thereof. Accordingly, the copolymer salts may also contain other moieties apart from maleic and itaconic moieties, such as vinyl moieties. However, such other moieties should be present only up to a level of about 15% by weight, more preferably up to about 7% by weight. Preferably, each of the copolymer consists essentially of maleic and itaconic moieties. One particularly preferred class of copolymer salts are the SFP AVAIL® and Nutrisphere-N® products described previously, which are formed using substantially equimolar amounts of maleic and itaconic moieties.

Most preferably, each of said partial salt copolymers has the generalized formula

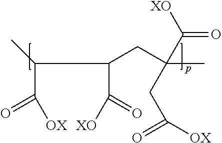

where some of said X cations are H, and others of said X cations are Ca in the case of the partial calcium salt copolymer and ammonium in the case of the partial ammonium salt copolymer, and p ranges from about 10-50.

The partial calcium salt copolymer initially (i.e., before mixing with the partial ammonium salt copolymer) should have a pH of from about 1-4; likewise, the partial ammonium salt copolymer initially should have a pH of from about 1-4. The most preferred initial pH level for both salt copolymers should be about 1-2.

The complete amendments should preferably contain at least about 30-60% by weight of total copolymer solids derived from both of the partial salt copolymers (more preferably from about 35-50% by weight solids), and from about 40-70% by weight water (most preferably from about 50-65% water). However, the amendments may also include other ingredients apart from the two partial salt copolymers and water, such as pH adjustment agents, buffering agents, preservatives, and emulsifiers. Any such other ingredients are preferably used at a minor level, e.g., from about 1-10% by weight. The pH of the complete amendments should be acid, preferably from about 1-5, more preferably from about 2-4.

Preferably, the calcium partial salt copolymer solids should be present in the complete amendments in an amount greater than the amount of the ammonium partial salt copolymer solids therein. That is, taking the total weight of both copolymer salt solids as 100% by weight, the calcium partial salt copolymer solids should be present at a level of from about 50-80% by weight (more preferably from about 55-75% by weight, and most preferably from about 60-65% by weight), and the ammonium partial salt copolymer solids should be present at a level of from about 20-50% by weight (more preferably from about 25-45% by weight, and most preferably from about 35-40% by weight).

The single most preferred formulation useful in the context of the invention is the previously described MTM® product.

### The Preferred Uses of the Amendments

Generally speaking, the amendments of the invention are administered to animals by adding the amendments to otherwise conventional animal feeds, and/or adding the amendments to the animal water supply.

In the case of poultry, use can be made of commercially available or custom poultry feeds, which are typically substantially dry and particulate in nature. Such feeds typically contain yellow corn at a level of from about 45-65% by weight, together with soybean at a level of from about 18-45% by weight. These feeds also commonly include a variety of other ingredients, such as meat and bone meals, fats, salt, limestone or oyster shell, amino acids, vitamins and minerals, and have analyses of protein (N×6.25) of from about 15-32%, and a Metabolizable Energy (ME) value of from about 1100-1600 kcal/lb. Further information about conventional poultry feeds can be found in Poultry Nutrition and Feeding, Section 12, Animal Nutrition Handbook, pp. 316-331 (2009), which is wholly incorporated herein by reference. The amendments of the invention, typically in liquid form, are sprayed or otherwise applied to the dry poultry feed ingredients with mixing, to substantially intersperse the copolymer materials with the feed ingredients. The improved feed is then fed ad libitum to poultry. The amendments should be present in an improved feed at a level of from about 0.05-0.25% by weight (more preferably from about 0.1-0.2% by weight), where the total weight of the supplemented or amended feed is taken as 100% by weight.

In the case of adding amendments to poultry water, the usage would typically be at a level of from about 0.01-0.25% by volume, more preferably from about 0.05-0.2% by volume, where the total amount of supplemented or amended water is taken as 100% by volume. Inasmuch as the preferred partial salt copolymers of the invention, and the MTM® product, are water soluble, it readily mixes and evenly disperses in the poultry water.

The amendments of the invention, used either with poultry feed or poultry water can be fed to virtually any poultry, e.g., chicken, duck, goose, peafowl, swan, ostrich, pigeon, turkey, guineafowl, pheasant, rhea, and emu.

Where the amendments are employed to supplement mammalian animal feeds and/or waters, the same general techniques and amounts of polymers are employed. For example, the amendments may be directly mixed with animal feeds or used as a top dressing thereon. Likewise, the animals' water supply is supplemented as described previously. The fact that the copolymers are water soluble greater facilitates uses thereof.

The following examples illustrate preferred animal feeds, waters, and methods of feeding and/or watering in accordance with the invention. It should be understood, however, that these examples are provided by way of illustration only, and nothing therein should be taken as a limitation upon the overall scope of the invention.

### Example 1

### Poultry

Twenty broiler chickens of common variety were separated into two groups denoted “A” and “B,” with group A being the research group, and B being the control group. The chickens were placed into conventional chicken coops made of wire and wood, with typical litter on the floor trays of the coops. Heat lamps were attached to each coop at identical locations, along with a gravity-fed one-gallon water container and a gravity-fed feeder. Plastic sheeting was placed over the coops in order to trap volatilizing ammonia with open-ventilation at the front and sides of the coops. The birds had access to water and feed during all daylight hours.

During the test, both the A and B groups were fed Purina Flock Raiser premium quality poultry feed. However, feed for the group A chickens was supplemented with 0.25% (w/w) of the previously described MTM® polymeric material, and the Group A water was also supplemented with 0.5% (v/v) of the MTM® material.

During the course of the test, all of the litter and liquid was collected in ten-gallon buckets when the coop trays were filled. Also, periodic ammonia readings were taken with a MiniRae 3000 PID handheld meter, with subsequent readings taken at the end of the experiment using a Drager X-AM 5000 handheld reactive meter, together with physical observations of odor. At the end of the test period, necropsies, tissue, and blood tests were taken of the test chickens.

Periodic ammonia readings were recorded in each coop litter tray, at bird level within each coop, in the air pocket above the coop, and inside the collection bucket with scraped litter from the tray. The following results were recorded.

TABLE 1

| | | | |
|---|---|---|---|
| Tray | Coop NH₃ | Pocket | Bucket NH₃- |
| NH₃-ppm | (ppm) | NH₃-ppm | ppm |

Group ID

| Day | A | B | A | B | A | B | A | B |
|---|---|---|---|---|---|---|---|---|
| 1 | 0 | 0 | 0 | 0 | 0 | 0 | 0 | 0 |
| 5 | 0.41 | 3.69 | 0.21 | 2.30 | 1.68 | 2.26 | 0 | 0 |
| 9 | 1.16 | 1.37 | 0.45 | 1.33 | 0.49 | 2.50 | 0 | 0 |
| 14 | 0.10 | 0.70 | 0 | 0 | 0.40 | 0.65 | 0 | 0 |
| 19 | 1.50 | 4.50 | 0 | 0 | 1.00 | 1.10 | 94 | 163 |
| 21 | 1.00 | 1.30 | 0.45 | 0.85 | 0.80 | 0.90 | 16 | 80 |
| 26 | 2.50 | 11 | 1.00 | 1.50 | 1.50 | 2.50 | 38 | 250 |
| 30 | 3.5 | 10 | 1.00 | 1.00 | 3.80 | 3.50 | 38 | 68 |
| 35 | 20.5 | 33 | 3.50 | 5.5 | 20 | 32 | 16 | 23¹ |
| 37 | 3.7 | 7 | 0.3 | 0.1 | 1.6 | 3.1 | 2.0 | 3.5² |
| 40 | 8 | 12 | 0 | 1.7 | 9.1 | 7.2 | 35 | 80³ |
| 49 | 0.5 | 0.5 | 0 | 0.5 | 0.5 | 0.5 | 49 | 300/149⁴ |

¹Measurement taken after bucket materials had dried, and lid opened
²Measurement taken after bucket materials had dried in the open
³Measurement taken after bucket lid removed
⁴Measurement of 300 ppm taken with bucket lid cracked; measurement of 149 ppm taken 60 seconds after lid opened.

These results confirm that the MTM® material is effective for reducing volatilization of ammonia. This was chiefly evident on the last day of sampling when looking at the accumulated manure and litter in the ten-gallon pails, not only by gas monitoring, but by physical observation as well. Little ammonia smell was observed in the group A bucket on the last day of tests, but the ammonia in the group B bucket was very strong and gave off an almost overwhelming odor. These reductions in ammonia emission are believed to be a direct effect of the MTM® material controlling ammonia volatilization, and establishes that the MTM® material can survive the digestive tracts of poultry, remaining intact and effective.

Bird weights were variable for the first two weeks of the test, and then stabilized with no significant difference between the groups. This suggests that the MTM® material did not affect the uptake of nutrients by the birds and had no physical effects or ailments on development.

The bird weight data is set forth in the following Table 2, which gives the total of the group A and B bird weights on the indicated dates.

TABLE 2

| Day | Group A - gms | Group B - gms |
|---|---|---|
| 1 | 766.5 | 751.5 |
| 5 | 2032.5 | 1901.5 |
| 9 | 2859.5 | 2626.5 |
| 14 | 5560 | 5236 |
| 19 | 8938.5 | 8933.5 |
| 21 | 12031.5 | 12153.5 |
| 23¹ | — | — |
| 30 | 15382 | 15732 |
| 34² | — | — |
| 40 | 14985 | 15218 |

¹Group A had a bird fatality, and accordingly one bird of the same sex was removed from group B
²Group A had two bird fatalities, and group B had 3 bird fatalities due to heat stress. A same sex bird was removed from group A

A private veterinarian performed necropsies and sampled tissues for normality, finding two abnormalities on two birds in group A which could not definitively be attributed to the MTM® material. The veterinarian reported that a gross necropsy was performed on six chickens from the research group A, and two chickens from the control group B. The two chickens necropsied from the control group were chosen at random, one male and one female. No abnormal findings were noted in either of the chickens necropsied from the control group. Necropsies were performed on all six chickens from the research group. Gross abnormalities were noted in two of the research chickens, nos. 2 and 4. In no. 2, hepatic nodules and hepatic enlargement with rounded edges of the liver were noted. In both nos. 2 and 4, renal hyperplasia with blood engorgement was noted. The noted abnormalities could have been caused by a number of disease processes. Liver and kidney samples were submitted for histopathological examination from two of the control chickens that were necropsied, and three of the research chickens. In addition, blood was submitted for analysis. The analysis showed the presence of a parasitic inflammation, which confirmed that the MTM® product did not affect the physiology of the birds.

### Example 2

### Cattle

In this test, eight Angus cross-bred heifer calves were first fed and watered together for ten days prior to beginning the study, to ensure that all calves were in good health and were acclimated to their new environment. The animals had weights of 300-400 lbs after the end of the acclimation period, or at Day 0 of the test. The eight animals were randomly separated into two groups of four, with one group designated as the research group and the other designated as the control group. Both groups were placed in semi-ventilation control pens, each approximately 20×30 feet, within a metal building. All calves received free choice water and equal amounts of grass hay and a standard composite feed. The research group composite feed included MTM® at the rate of 0.25% (w/w), and the research group water was supplemented with MTM® at a rate of 0.25% (v/v). The control group animals received the same amounts of feed, hay, and water, without any MTM® supplementation. Both groups were fed their respective feeds and waters for 105 days.

Average daily weight gain was determined to understand what effect the polymer amendment had on performance. Blood samples were also obtained for chemical analyses approximately every 30 days, in order to compare any differences between he control and research animals. Ammonia levels were randomly measured using a MiniRae 3000 photoionization detector. At the completion of the study, a randomly selected calf from each group was euthanized, and gross necropsies and tissue collections were performed.

Average Day 0 animal weights were 366.5 lbs for the control group and 352.5 lbs for the research group. Average Day 105 animal weights were 585.5 lbs for the control group, and 570 lbs for the research group. The average daily gain was determined by the total weight gained during the study, divided by 105 days. Average daily gain was 2.08 lbs/day for the control group, and 2.07 lbs/day for the research group. There was no statistically significant difference in average weight gain between the groups.

Blood was collected at approximately 30-day intervals and was submitted to the University of Missouri Diagnostic Laboratory for chemical analysis. The analyses included CGT, AST, direct bilirubin, total bilirubin, magnesium, phosphorus, calcium, globulin, total protein, albumin, anion gap, total CO2, chloride, potassium, sodium, creatinine, and urea nitrogen. No statistically significant changes were noted between the groups based upon the chemical analyses.

Throughout the study, ammonia levels within the calf pens were taken using a photoionization detector (PID). Gas measurements were taken by placing the meter 20-30 cm off the pen floors at four random points within each pen. At each location, measurements were taken for 2.5 minutes, for a total measurement time of 10 minutes. During a testing period, an average gas measurement and a peak reading was determined; the peak readings were taken as the highest 10-second mean determined by the meter, whereas the average measurement was the 2.5 minute mean rating at each data collection point.

### Test 1

| Point | Research Group | Average | Control Group | Average |
|---|---|---|---|---|
| 1 | 0.50 ppm NH3 | 0.14 ppm | 4.8 ppm NH3 | 1.7 ppm NH3 |
| | | NH3 | | |
| 2 | 2.1 ppm NH3 | 0.46 ppm | 3.0 ppm NH3 | 0.58 ppm NH3 |
| | | NH3 | | |
| 3 | 1.5 ppm NH3 | 0.91 ppm | 1.4 ppm NH3 | 0.88 ppm NH3 |
| | | NH3 | | |
| 4 | 1.2 ppm NH3 | 0.97 ppm | 4.1 ppm NH3 | 2.4 ppm NH3 |
| | | NH3 | | |
| Mean | 1.3 ppm NH3 | 0.62 ppm | 3.3 ppm NH3 | 1.4 ppm NH3 |
| | | NH3 | | |

### Test 2

| | Research | | | |
|---|---|---|---|---|
| Point | Group | Average | Control Group | Average |
| 1 | 0.10 ppm NH3 | 0.03 ppm NH3 | 7.9 ppm NH3 | 2.6 ppm NH3 |
| 2 | 2.4 ppm NH3 | 0.74 ppm NH3 | 7.9 ppm NH3 | 3.7 ppm NH3 |
| 3 | 3.8 ppm NH3 | 1.6 ppm NH3 | 3.3 ppm NH3 | 1.9 ppm NH3 |
| 4 | 0.50 ppm NH3 | 0.24 ppm NH3 | 2.7 ppm NH3 | 1.2 ppm NH3 |
| Mean | 1.7 ppm NH3 | 0.65 ppm NH3 | 5.5 ppm NH3 | 2.4 ppm NH3 |

### Test 3

| | Research | | | |
|---|---|---|---|---|
| Point | Group | Average | Control Group | Average |
| 1 | 3.5 ppm NH3 | 1.2 ppm NH3 | 4.4 ppm NH3 | 1.2 ppm NH3 |
| 2 | 0.90 ppm NH3 | 0.23 ppm NH3 | 4.2 ppm NH3 | 2.2 ppm NH3 |
| 3 | 3.1 ppm NH3 | 0.60 ppm NH3 | 2.6 ppm NH3 | 1.4 ppm NH3 |
| 4 | 3.4 ppm NH3 | 1.6 ppm NH3 | 4.8 ppm NH3 | 2.2 ppm NH3 |
| Mean | 2.7 ppm NH3 | 0.91 ppm NH3 | 4.0 ppm NH3 | 1.8 ppm NH3 |

### Test 4

| | Research | | | |
|---|---|---|---|---|
| Point | Group | Average | Control Group | Average |
| 1 | 3.6 ppm NH3 | 1.0 ppm NH3 | 5.3 ppm NH3 | 1.9 ppm NH3 |
| 2 | 2.9 ppm NH3 | 0.86 ppm NH3 | 4.7 ppm NH3 | 3.5 ppm NH3 |
| 3 | 1.4 ppm NH3 | 0.27 ppm NH3 | 5.2 ppm NH3 | 1.7 ppm NH3 |
| 4 | 3.9 ppm NH3 | 1.6 ppm NH3 | 3.5 ppm NH3 | 1.9 ppm NH3 |
| Mean | 3.0 ppm NH3 | 0.93 ppm NH3 | 4.7 ppm NH3 | 2.3 ppm NH3 |

The test results confirmed that the use of the copolymers as feed and water amendments have no statistically significant effect on average daily weight gain or blood chemistry. However, the research group gave statistically significant reductions in ammonia levels, as compared with the control group.

Feed and/or water amendments using the copolymers of the invention have a beneficial effect with a wide variety of livestock, e.g., mammals such as cattle, sheep, swine, and horses.

I claim:

1. An improved animal feed comprising quantities of feed ingredients normally fed to the animal, and an amount of a feed amendment including a partial calcium salt of a maleic-itaconic copolymer and a partial ammonium salt of a maleic-itaconic copolymer, said amount of said amendment sufficient to reduce volatilized ammonia derived from the excrement of the animal fed the improved animal feed, as compared with the volatilized ammonia of an animal fed an identical feed, without said amendment.

2. The improved poultry feed of claim 1, said feed being substantially dry, said amendment comprising an aqueous mixture of said partial calcium salt copolymer and said partial ammonium salt copolymer, intermixed with said feed ingredients.

3. The improved animal feed of claim 1, said amendment being present with said feed at a level of from about 0.05-0.25% by weight, with the total weight of the amended feed being taken as 100% by weight.

4. The improved animal feed of claim 3, said level being from about 0.1-0.2% by weight.

5. The improved animal feed of claim 1, said amendment being intermixed with the other ingredients of said feed.

6. The improved animal feed of claim 1, said amendment comprising from about 40-80% by weight of partial calcium salt copolymer solids, and from about 20-60% by weight of partial ammonium salt copolymer solids, with the total amount of the solids taken as 100% by weight.

7. The improved animal feed of claim 6, said amendment comprising from about 55-75% by weight of said partial calcium salt copolymer solids and from about 25-45% by weight of said partial ammonium salt copolymer.

8. The improved animal feed of claim 1, each of said partial salt copolymers having at least about 85% by weight of maleic and itaconic moieties therein.

9. The improved animal feed of claim 8, each of said partial salt copolymers having at least about 93% by weight of maleic and itaconic moieties therein.

10. The improved animal feed of claim 9, each of said partial salt copolymers consisting essentially of maleic and itaconic moieties.

11. The improved animal feed of claim 1, each of said partial salt copolymers comprising from about 10-90% maleic moieties and from 90-10% itaconic moieties.

12. The improved animal feed of claim 11, each of said partial salt copolymers having substantially equimolar amounts of said maleic and itaconic moieties.

13. The improved animal feed of claim 1, said amendment having a solids content of from about 30-60% by weight.

14. The improved animal feed of claim 1, each of said partial salt copolymers having the generalized formula 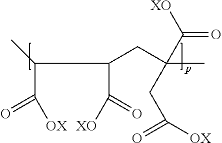
where some of said X cations are H, and others of said X cations are Ca in the case of the partial calcium salt copolymer and ammonium in the case of the partial ammonium salt copolymer, and p ranges from about 10-50.

15. The improved animal feed of claim 1, said feed designed to be fed to poultry selected from the group consisting of chicken, duck, goose, peafowl, swan, ostrich, pigeon, turkey, guineafowl, pheasant, rhea, and emu, and said feed including quantities of corn and soy bean meal.

16. A method of reducing volatilized ammonia derived from the excrement of animals, comprising the step of administering to the animals an amendment including a partial calcium salt of a maleic-itaconic copolymer and a partial ammonium salt of a maleic-itaconic copolymer, said amendment being administered in an amount sufficient to reduce volatilized ammonia derived from the excrement of the animals receiving said amendment, as compared with the volatilized ammonia derived from excrement of animals not receiving said amendment.

17. The method of claim 16, said amendment being administered by adding the amendment to the water and/or feed consumed by the animals.

18. The method of claim 17, said amendment being added to the animals' feed.

19. The method of claim 18, said poultry animal feed being substantially dry, said amendment comprising an aqueous mixture of said partial calcium salt copolymer and said partial ammonium salt copolymer, intermixed with said substantially dry feed.

20. The method of claim 19, said amendment being present at a level of from about 0.05-0.25% by weight, with the total weight of the amended animal feed being taken as 100% by weight.

21. The method of claim 20, said level being from about 0.1-0.2% by weight.

22. The method of claim 16, said amendment comprising from about 40-80% by weight of partial calcium salt copolymer solids, and from about 20-60% by weight of partial ammonium salt copolymer solids, with the total amount of the copolymer solids taken as 100% by weight.

23. The method of claim 22, said amendment comprising from about 55-75% by weight of said partial calcium salt copolymer solids and from about 25-45% by weight of said partial ammonium salt copolymer.

24. The method of claim 16 each of said partial salt copolymers having at least about 85% by weight of maleic and itaconic moieties therein.

25. The method of claim 24, each of said partial salt copolymers having at least about 93% by weight of maleic and itaconic moieties therein.

26. The method of claim 25, each of said partial salt copolymers consisting essentially of maleic and itaconic moieties.

27. The method of claim 16, each of said partial salt copolymers comprising from about 10-90% maleic moieties and from 90-10% itaconic moieties.

28. The method of claim 27, each of said partial salt copolymers having substantially equimolar amounts of said maleic and itaconic moieties.

29. The method of claim 16, said amendment being liquid and having a solids content of from about 30-60% by weight.

30. The method of claim 16, each of said partial salt copolymers having the generalized formula 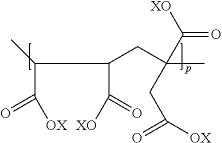
where some of said X cations are H, and others of said X cations are Ca in the case of the partial calcium salt copolymer and ammonium in the case of the partial ammonium salt copolymer, and p ranges from about 10-50.

31. The method of claim 16, said animals being poultry selected from the group consisting of chicken, duck, goose, peafowl, swan, ostrich, pigeon, turkey, guineafowl, pheasant, rhea, and emu, said poultry feed comprising quantities of corn and soybean meal.

32. The method of claim 16, including the step of adding said amendment to the water consumed by the animals.

33. The method of claim 32, said amendment being present in said water at a level of from about 0.01-0.25% by volume, where the total volume of the amended water is taken as 100% by volume.

34. An improved animal water comprising water and amendment dispersed in the water, said amendment comprising a partial calcium salt of a maleic-itaconic copolymer and a partial ammonium salt of a maleic-itaconic copolymer, said amendment being present in said water at a level of from about 0.01-0.25% by volume, where the total volume of the amended water is taken as 100% by volume.

35. The improved animal water of claim 34, said amendment comprising from about 40-80% by weight of partial calcium salt copolymer solids, and from about 20-60% by weight of partial ammonium salt copolymer solids, with the total amount of the solids taken as 100% by weight.

36. The improved animal water of claim 35, said amendment comprising from about 55-75% by weight of said partial calcium salt copolymer solids and from about 25-45% by weight of said partial ammonium salt copolymer.

37. The improved animal water of claim 34, each of said partial salt copolymers having at least about 85% by weight of maleic and itaconic moieties therein.

38. The improved animal water of claim 37, each of said partial salt copolymers having at least about 93% by weight of maleic and itaconic moieties therein.

39. The improved animal water of claim 38, each of said partial salt copolymers consisting essentially of maleic and itaconic moieties.

40. The improved animal water of claim 34, each of said partial salt copolymers comprising from about 10-90% maleic moieties and from 90-10% itaconic moieties.

41. The improved animal water of claim 40, each of said partial salt copolymers having substantially equimolar amounts of said maleic and itaconic moieties.

42. The improved animal water of claim 34, said amendment having a solids content of from about 30-60% by weight.

43. The improved animal water of claim 34, each of said partial salt copolymers having the generalized formula 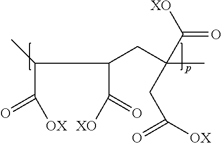
where some of said X cations are H, and others of said X cations are Ca in the case of the partial calcium salt copolymer and ammonium in the case of the partial ammonium salt copolymer, and p ranges from about 10-50.

44. The improved animal water of claim 34, said amendment being present at a level of from about 0.1-0.2% by volume.
